(19) United States
(12) Patent Application Publication
(10) Pub. No.: US 2013/0141787 A1
(43) Pub. Date: Jun. 6, 2013

(54) POLARIZER HAVING HIGH DURABILITY AND METHOD OF FABRICATING THE SAME

(71) Applicants: Pil Joo KIM, Uiwang-si (KR); Jae Bin SONG, Uiwang-si (KR); Hae Ryong CHUNG, Uiwang-si (KR)

(72) Inventors: Pil Joo KIM, Uiwang-si (KR); Jae Bin SONG, Uiwang-si (KR); Hae Ryong CHUNG, Uiwang-si (KR)

(21) Appl. No.: 13/690,358

(22) Filed: Nov. 30, 2012

(30) Foreign Application Priority Data
Dec. 2, 2011 (KR) 10-2011-0128666

(51) Int. Cl. G02B 1/08

(52) U.S. Cl. CPC G02B 1/08
USPC 359/487.02; 252/585

(57) ABSTRACT

A polarizer includes boric acid and potassium iodide. A ratio of weight percent of the boric acid to weight percent of the potassium iodide is within a range of about 5 to about 10 in the polarizer.

### CROSS-REFERENCE TO RELATED APPLICATION

The present application claims priority under 35 U.S.C. §119 to Korean Patent Application No. 10-2011-0128666, filed on Dec. 2, 2011, in the Korean Intellectual Property Office, and entitled: “Polarizer Having High Durability And Method Of Fabricating The Same,” which is incorporated by reference herein in its entirety.

### BACKGROUND

A liquid crystal display (LCD) is one of the most widely used flat panel displays. The LCD includes an LCD panel, which includes two substrates each having electric field generating electrodes and a liquid crystal layer interposed therebetween. The LCD displays an image by applying voltage across the electrodes to generate an electric field in the liquid crystal layer so as to determine orientations of liquid crystal molecules in the liquid crystal layer, while controlling polarization of incident light.

### SUMMARY

Embodiments may be realized by providing a polarizer that includes boric acid and potassium iodide, and a ratio of weight percent of the boric acid to weight percent of the potassium iodide is from about 5 to about 10 in the polarizer.

The ratio may be from about 6.5 to about 8.5. The ratio may be from about 5 to about 6. The polarizer may include about 18 wt % to about 22 wt % of boric acid and about 2 wt % to about 4 wt % of potassium iodide.

The polarizer may have an orthogonal chromaticity variation (Δab) from about 1 to about 4 as calculated by Equation 1:

Δab=\sqrt{(ac₃−ac₀)²+(bc₃−bc₀)²} (1)

wherein ac₃ and bc₃ each represent an orthogonal chromaticity of the polarizer after the polarizer has been left at 105° C. for 3 hours, and ac₀ and bc₀ each represent an initial orthogonal chromaticity of the polarizer. The orthogonal chromaticity variation (Δab) may be from about 1.5 to about 2.

The boric acid and the potassium iodide may be dispersed in an elongated polyvinyl alcohol film. The boric acid may be contained in an amount from about 18 wt % to about 22 wt % in the elongated polyvinyl alcohol film and the boric acid may be contained in an amount from about 2 wt % to about 4 wt % in the elongated polyvinyl alcohol film.

Embodiments may also be realized by providing a method of fabricating a polarizer that includes stretching a polyvinyl alcohol film while dyeing the polyvinyl alcohol film in a dyeing bath containing iodine and potassium iodide to form a dyed polyvinyl alcohol film, stretching the dyed polyvinyl alcohol film in a stretching bath containing boric acid and potassium iodide to form a stretched polyvinyl alcohol film, and stretching the stretched polyvinyl alcohol film in a color correction bath containing boric acid and potassium iodide.

The stretching bath may contain about 2.5 wt % to about 3.5 wt % of boric acid, about 2.5 wt % to about 3.5 wt % of potassium iodide, and a balance of water, and during stretching of the dyed polyvinyl alcohol film, the stretching bath may be maintained at a temperature of about 45° C. to about 65° C.

The color correction bath may contain about 0.8 wt % to about 1.2 wt % of boric acid, about 3.0 wt % to about 4.0 wt % of potassium iodide, and a balance of water, and during stretching of the stretched polyvinyl alcohol film, the color correction bath may be maintained at a temperature of about 35° C. to about 45° C.

The polyvinyl alcohol film may be stretched to a first cumulative stretching ratio of about 1.5 to about 2.2 in the dyeing bath, the dyed polyvinyl alcohol film may be stretched to a second cumulative stretching ratio of about 2.0 to about 3.2 in the stretching bath, and the stretched polyvinyl alcohol film may be stretched to a total stretching ratio of about 5 to about 6.5 in the color correction bath.

The method may include, prior to stretching the polyvinyl alcohol film in the dyeing bath, swelling a precursor polyvinyl alcohol film in a swelling bath to a preliminary stretching ratio of about 1.1 to about 1.6.

Stretching the stretched polyvinyl alcohol film in the color correction bath may form an elongated polyvinyl alcohol film that includes boric acid and potassium iodide, and a ratio of the boric acid to the potassium iodide may be from about 5 to about 10. The ratio in the elongated polyvinyl alcohol film may be from about 6.5 to about 8.5. The ratio in the elongated polyvinyl alcohol film may be from about 5 to about 6.

A further aspect of the embodiments provides a polarizing plate. The polarizing plate includes the polarizer as set forth in the above, and as manufactured as set forth in the above, and a protective film stacked on at least one side of the polarizer.

### BRIEF DESCRIPTION OF THE DRAWING

Features will become apparent to those of skill in the art by describing in detail example embodiments with reference to the attached drawing in which:

FIG. 1 illustrates a sectional view of a polarizing plate according to an exemplary embodiment.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art. In the drawing FIGURE, the dimensions of layers and regions may be exaggerated for clarity of illustration.

According to an exemplary embodiment, a polarizer includes boric acid and potassium iodide. A ratio (W_{BA}/W_{KI}) of weight percent of boric acid (W_{BA}) to weight percent of potassium iodide (W_{KI}) ranges from about 5 to about 10. However, the t ratio range is not limited thereto, e.g., the ratio may range from about 6.5 to about 8.5, from about 5 to about 6, from about 7 to about 9, from about 5.5 to about 8.5, from about 6 to about 8, from about 7.5 to about 8.5, etc.

If the ratio of weight percent of boric acid to weight percent of potassium iodide (W_{BA}/W_{KI}) is greater than or equal to about 5, the polarizer may decrease and/or minimize a variation in orthogonal chromaticity and/or may increase, improve, and/or provide optical durability. If the ratio of weight percent of boric acid to weight percent of potassium iodide (W_{BA}/W_{KI}) is equal to or less than about 10, the polarizer may decrease and/or minimize a variation in orthogonal chromaticity and/or may increase, improve, and/or provide optical durability, external appearance, and/or transmittance.

According to an exemplary embodiment, the polarizer may contain an amount of about 18 wt % to about 22 wt % of boric acid. However, embodiments are not limited thereto, e.g., the amount of boric acid may be from about 18.5 wt % to about 21.5 wt %, from about 19 wt % to about 21 wt %, from about 17.5 wt % to about 20 wt %, from about 20 wt % to about 22 wt %, from about 18 wt % to about 19.5 wt %, etc. Within this range, the polarizer may have excellent optical durability, may provide a good degree of polarization while minimizing chromaticity variation, and minimizing or preventing fracture of the film in a stretching process.

The polarizer may contain an amount of about 2 wt % to about 4 wt % of potassium iodide. However, embodiments are not limited thereto, e.g., the amount of potassium iodide may be from about 3 wt % to about 3.8 wt %, from about 2.5 wt % to about 3.5 wt %, from about 3.2 wt % to about 3.6 wt %, from about 2.0 wt % to about 2.8 wt %, etc. Within this range, the polarizer may have excellent optical durability while minimizing chromaticity variation, and minimizing or preventing bluish discoloration and deterioration of the degree of polarization.

The polarizer may have an orthogonal chromaticity variation (Δab) from about 1 to about 4. However, the range for the orthogonal chromaticity variation (Δab) is not limited thereto, e.g., the range may be from about 1 to about 3, from about 1 to about 2, from about 1.5 to about 2, etc. The orthogonal chromaticity variation (Δab) is calculated by Equation 1:

Δab=\sqrt{(ac₃−ac₀)²+(bc₃−bc₀)²} (1)

wherein ac₃ and bc₃ are each an orthogonal chromaticity of the polarizer after the polarizer has been left at 105° C. for 3 hours, and ac₀ and bc₀ are each an initial orthogonal chromaticity of the polarizer. For example, the orthogonal chromaticity variation (Δab) represents a specific calculation of variance or change in orthogonal chromaticity of the polarizer as measured, e.g., in two regions of the polarizer, after being exposed to a temperature of 105° C. for a total of 3 hours.

According to exemplary embodiments, a method of fabricating a polarizer includes, e.g., stretching a polyvinyl alcohol film while dyeing the polyvinyl alcohol film in a dyeing bath containing iodine and potassium iodide to form a dyed polyvinyl alcohol film, stretching the dyed polyvinyl alcohol film in a stretching bath containing boric acid and potassium iodide to form a stretched polyvinyl alcohol film, and stretching the stretched polyvinyl alcohol film in a color correction bath containing boric acid and potassium iodide.

For example, any polyvinyl alcohol film commonly used in the manufacture of a polarizer may be used in the above method of fabricating the polarizer using the dyeing bath, the stretching bath, and the color correction bath. According to an exemplary embodiment, the polyvinyl alcohol film may have a degree of polymerization in the range of about 1,000 to about 3,500, and may have a degree of saponification of about 99.8 mol % or more, without being limited thereto.

The polyvinyl alcohol film may be subjected to swelling before being dyeing with iodine. Swelling of the polyvinyl alcohol film may be performed at about 22° C. to about 32° C. in a swelling bath, e.g., to remove foreign matter from the surface of the film and/or to enhance dyeing performance, to form a swollen polyvinyl alcohol film. The swelling bath may contain at least one of water, chloride, boric acid, inorganic acid, organic solvent, and the like. For example, preparation and selection of the swelling bath may be performed by a person having ordinary knowledge in the art.

In some embodiments, the polyvinyl alcohol film may be stretched in the swelling bath, e.g., the polyvinyl alcohol film may be stretched to a cumulative stretching ratio of about 1.1 to about 1.6 in the swelling bath. The stretching ratio may represent a ratio of a length of the swollen polyvinyl alcohol film after being exposed to the swelling bath to a length of the polyvinyl alcohol film before being exposed to the swelling bath.

The swollen polyvinyl alcohol film may then be subjected to dyeing in a dyeing bath to form a dyed polyvinyl alcohol film. The dyeing bath may contain iodine and potassium iodide. In some embodiments, the iodine dyeing bath may contain about 0.05 to about 0.2 parts by weight of iodine and about 0.5 to about 2.5 parts by weight of potassium iodide based on 100 parts by weight of water. Dyeing with iodine may be performed at about 20° C. to about 40° C. The swollen polyvinyl alcohol film may be subjected to stretching to a cumulative stretching ratio of about 1.5 to about 2.2 in the dyeing bath. For example, the cumulative stretching ratio may represent a ratio of a length of the dyed polyvinyl alcohol film to the length of the polyvinyl alcohol film before being exposed to the swelling bath.

The dyed polyvinyl alcohol film may then be subjected to stretching in a stretching bath containing boric acid and potassium iodide to form a stretched polyvinyl alcohol film. Stretching of the dyed polyvinyl alcohol film may be performed by a typical method. In some embodiments, the dyed polyvinyl alcohol film may be subjected to stretching to a cumulative stretching ratio of about 2.0 to about 3.2 in the stretching bath. The cumulative stretching ratio may represent a ratio of a length of the stretched polyvinyl alcohol film to the length of the polyvinyl alcohol film before being exposed to the swelling bath.

In an exemplary embodiment, the stretching bath may contain about 2.5 wt % to about 3.5 wt % of boric acid, about 2.5 wt % to about 3.5 wt % of potassium iodide, and a balance and/or remainder of water. For example, the stretching bath may only include boric acid, potassium iodide, and water. The stretching bath may be maintained at a temperature of about 45° C. to about 65° C.

Then, the polyvinyl alcohol film stretched in the stretching bath, i.e., the stretched polyvinyl alcohol film, may be subjected to crosslinking and stretching in a color correction bath containing boric acid and potassium iodide. The color correction bath may contain about 0.8 wt % to about 1.2 wt % of boric acid, about 3.0 wt % to about 4.0 wt % of potassium iodide, and a balance and/or remainder of water. For example, the color correction bath may only include boric acid, potassium iodide, and water. The color correction bath may be maintained at a temperature of about 35° C. to about 45° C.

In the color correction bath, the stretched polyvinyl alcohol film may be further stretched to a total stretching ratio of about 5 to about 6.5 to form a finally elongated polyvinyl alcohol film. For example, the total stretching ratio may be about 5.8 to about 6.2, or the total stretching ratio may be about 5.9 to about 6.1. For example, the total stretching ratio may represent a ratio of a length of the finally elongated polyvinyl alcohol film to the length of the polyvinyl alcohol film before being exposed to the swelling bath.

The prepared polarizer according to an exemplary embodiment may have a thickness ranging from about 0.5 μm to about 400 μm. For example, the thickness may be from about 5 μm to about 200 μm. The prepared polarizer may include both boric acid and potassium iodide therein, e.g., dispersed therein. A weight ratio of a weight of the boric acid to a weight of the potassium iodide in the polarizer may be from about 5 to about 10. Further, the polarizer may have an orthogonal chromaticity variation (Δab) from about 1 to about 4.

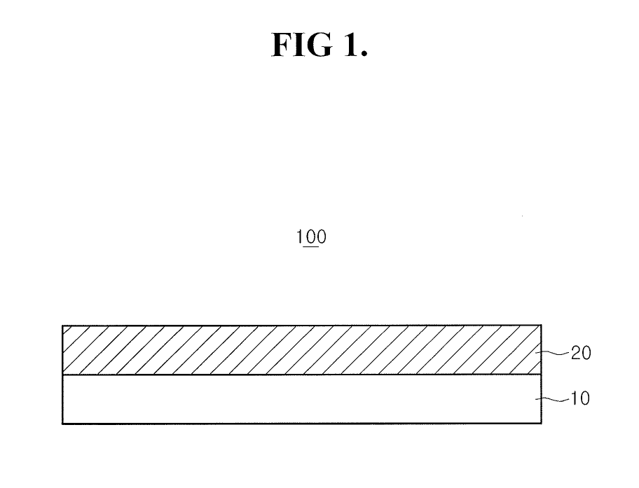

In a further aspect, FIG. 1 illustrates a sectional view of a polarizing plate including a polarizer according to an exemplary embodiment. In this embodiment, the polarizing plate 100 includes a protective film 20 formed on at least one side of the polarizer 10. The protective film may act as a phase retardation film, a brightness enhancing film, a reflective film, a translucent reflection film, a diffusive film, an optical compensation film, and the like. According to another exemplary embodiment, at least one of as a phase retardation film, a brightness enhancing film, a reflective film, a translucent reflection film, a diffusive film, an optical compensation film, and the like, may be further stacked on the protective film 20.

The protective film 20 may have a thickness ranging from about 50 μm to about 400 μm. For example, the thickness may range from about 70 μm to about 200 μm. The protective film may be stacked on the polarizer via, e.g., adhesives.

The stages described above for fabricating a polarizer represent an exemplary embodiment. Further, the order the stages are performed in is not limited to the above exemplary embodiment. Descriptions of details apparent to those skilled in the art have been omitted herein.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES

### Example 1

A polyvinyl alcohol film having an initial thickness of 75 μm (VF-PS #7500, polymerization degree: 2,400, width: 3,000 mm, saponification degree: 99.9 mol % or more, Kuraray Co., Ltd.) was swollen to a cumulative stretching ratio of 1.40 in a swelling bath filled with deionized water at 30° C., in which the film was maintained in a tensioned state. Then, the resultant film was dyed and stretched to a cumulative stretching ratio of 1.70 in a dyeing bath filled with an aqueous dyeing solution containing iodine and potassium iodide in a weight ratio of 1:23 at 30° C. Then, the dyed film was stretched to a stretching ratio of 2.5 in an aqueous stretching solution containing 3.0 wt % of boric acid and 3.0 wt % of potassium iodide at 55° C., followed by uniaxial stretching to a total stretching ratio of 6.0 in a color correction bath containing 1.0 wt % of boric acid and 4.0 wt % of potassium iodide at 40° C. Then, the stretched film was dried at 50° C. for 4 minutes, thereby preparing an iodine-based polarizer having a thickness of 28 μm. With adhesives applied to both sides of the prepared polarizer, 80 μm thick triacetylcellulose films each subjected to surface saponification (Fujitack T80UNL, Fuji Film Corporation) were attached to both sides of the polarizer and dried at 60° C. for 5 minutes, thereby preparing a polarizing plate.

### Example 2

A polyvinyl alcohol film having an initial thickness of 75 μm (VF-PS #7500, polymerization degree: 2,400, width: 3,000 mm, saponification degree: 99.9 mol % or more, Kuraray Co., Ltd.) was swollen to a cumulative stretching ratio of 1.40 in a swelling bath filled with deionized water at 30° C., in which the film was maintained in a tensioned state. Then, the resultant film was dyed and stretched to a cumulative stretching ratio of 1.70 in a dyeing bath filled with an aqueous dyeing solution containing iodine and potassium iodide in a weight ratio of 1:23 at 30° C. Then, the dyed film was stretched to a stretching ratio of 2.5 in an aqueous stretching solution containing 3.0 wt % of boric acid and 3.0 wt % of potassium iodide at 54° C., followed by uniaxial stretching to a total stretching ratio of 6.0 in a color correction bath containing 1.0 wt % of boric acid and 3.0 wt % of potassium iodide at 40° C. Then, the stretched film was dried at 50° C. for 4 minutes, thereby preparing an iodine-based polarizer having a thickness of 28 μm. With adhesives applied to both sides of the prepared polarizer, 80 μm thick triacetylcellulose films each subjected to surface saponification (Fujitack T80UNL, Fuji Film Corporation) were attached to both sides of the polarizer and dried at 60° C. for 5 minutes, thereby preparing a polarizing plate.

### Example 3

A polyvinyl alcohol film having an initial thickness of 75 μm (VF-PS #7500, polymerization degree: 2,400, width: 3,000 mm, saponification degree: 99.9 mol % or more, Kuraray Co., Ltd.) was swollen to a cumulative stretching ratio of 1.40 in a swelling bath filled with deionized water at 30° C., in which the film was maintained in a tensioned state so as not to be loose. Then, the resultant film was dyed and stretched to a cumulative stretching ratio of 1.70 in a dyeing bath filled with an aqueous dyeing solution containing iodine and potassium iodide in a weight ratio of 1:23 at 30° C. Then, the dyed film was stretched to a stretching ratio of 2.5 in an aqueous stretching solution containing 3.2 wt % of boric acid and 3.0 wt % of potassium iodide at 53° C., followed by uniaxial stretching to a total stretching ratio of 6.0 in a color correction bath containing 1.0 wt % of boric acid and 3.0 wt % of potassium iodide at 40° C. Then, the stretched film was dried at 50° C. for 4 minutes, thereby preparing an iodine-based polarizer having a thickness of 28 μm. With adhesives applied to both sides of the prepared polarizer, 80 μm thick triacetylcellulose films each subjected to surface saponification (Fujitack T80UNL, Fuji Film Corporation) were attached to both sides of the polarizer and dried at 60° C. for 5 minutes, thereby preparing a polarizing plate.

### Example 4

A polyvinyl alcohol film having an initial thickness of 75 μm (VF-PS #7500, polymerization degree: 2,400, width: 3,000 mm, saponification degree: 99.9 mol % or more, Kuraray Co., Ltd.) was swollen to a cumulative stretching ratio of 1.40 in a swelling bath filled with deionized water at 30° C., in which the film was maintained in a tensioned state. Then, the resultant film was dyed and stretched to a cumulative stretching ratio of 1.70 in a dyeing bath filled with an aqueous dyeing solution containing iodine and potassium iodide in a weight ratio of 1:23 at 30° C. Then, the dyed film was stretched to a stretching ratio of 2.5 in an aqueous stretching solution containing 3.5 wt % of boric acid and 3.0 wt % of potassium iodide at 60° C., followed by uniaxial stretching to a total stretching ratio of 6.0 in a color correction bath containing 1.0 wt % of boric acid and 4.0 wt % of potassium iodide at 40° C. Then, the stretched film was dried at 50° C. for 4 minutes, thereby preparing an iodine-based polarizer having a thickness of 28 p.m. With adhesives applied to both sides of the prepared polarizer, 80 μm thick triacetylcellulose films each subjected to surface saponification (Fujitack T80UNL, Fuji Film Corporation) were attached to both sides of the polarizer and dried at 60° C. for 5 minutes, thereby preparing a polarizing plate.

### Comparative Example 1

A PVA film having a thickness of 75 μm (VF-PS #7500, polymerization degree: 2,400, width: 3,000 mm, saponification degree: 99.9 mol % or more, Kuraray Co., Ltd.) was swollen to a cumulative stretching ratio of 1.40 in a swelling bath filled with deionized water at 30° C., in which the film was maintained in a tensioned state. Then, the resultant film was dyed and stretched to a cumulative stretching ratio of 1.70 in a dyeing bath filled with an aqueous dyeing solution containing iodine and potassium iodide in a weight ratio of 1:23 at 30° C. Then, the dyed film was stretched to a stretching ratio of 2.5 in an aqueous stretching solution containing 2.0 wt % of boric acid and 3.0 wt % of potassium iodide at 60° C., followed by uniaxial stretching to a total stretching ratio of 6.0 in a color correction bath containing 1.0 wt % of boric acid and 4.0 wt % of potassium iodide at 40° C. Then, the stretched film was dried at 50° C. for 4 minutes, thereby preparing an iodine-based polarizer having a thickness of 28 μm. With adhesives applied to both sides of the prepared polarizer, 80 μm thick triacetylcellulose films each subjected to surface saponification (Fujitack T80UNL, Fuji Film Corporation) were attached to both sides of the polarizer and dried at 60° C. for 5 minutes, thereby preparing a polarizing plate.

### Comparative Example 2

A PVA film having a thickness of 75 μm (VF-PS #7500, polymerization degree: 2,400, width: 3,000 mm, saponification degree: 99.9 mol % or more, Kuraray Co., Ltd.) was swollen to a cumulative stretching ratio of 1.40 in a swelling bath filled with deionized water at 30° C., in which the film was maintained in a tensioned state so as not to be loose. Then, the resultant film was dyed and stretched to a cumulative stretching ratio of 1.70 in a dyeing bath filled with an aqueous dyeing solution containing iodine and potassium iodide in a weight ratio of 1:23 at 30° C. Then, the dyed film was stretched to a stretching ratio of 2.5 in an aqueous stretching solution containing 3.5 wt % of boric acid and 3.0 wt % of potassium iodide at 50° C., followed by uniaxial stretching to a total stretching ratio of 6.0 in a color correction bath containing 1.0 wt % of boric acid and 4.0 wt % of potassium iodide at 40° C. Then, the stretched film was dried at 50° C. for 4 minutes, thereby preparing an iodine-based polarizer having a thickness of 28 μm. With adhesives applied to both sides of the prepared polarizer, 80 μm thick triacetylcellulose films each subjected to surface saponification (Fujitack T80UNL, Fuji Film Corporation) were attached to both sides of the polarizer and dried at 60° C. for 5 minutes, thereby preparing a polarizing plate.

### Comparative Example 3

A PVA film having a thickness of 75 μm (VF-PS #7500, polymerization degree: 2,400, width: 3,000 mm, saponification degree: 99.9 mol % or more, Kuraray Co., Ltd.) was swollen to a cumulative stretching ratio of 2.3 in a swelling bath filled with deionized water at 30° C., in which the film was maintained in a tensioned state. Then, the resultant film was dyed and stretched to a cumulative stretching ratio of 2.8 in a dyeing bath filled with an aqueous dyeing solution containing iodine and potassium iodide in a weight ratio of 1:23 at 30° C. Then, the dyed film was stretched to a stretching ratio of 2.0 in an aqueous stretching solution containing 3.0 wt % of boric acid and 3.0 wt % of potassium iodide at 54° C., followed by uniaxial stretching to a total stretching ratio of 6.0 in a color correction bath containing 1.0 wt % of boric acid and 3.0 wt % of potassium iodide at 40° C. Then, the stretched film was dried at 50° C. for 4 minutes, thereby preparing an iodine-based polarizer having a thickness of 28 μm. With adhesives applied to both sides of the prepared polarizer, 80 μm thick triacetylcellulose films each subjected to surface saponification (Fujitack T80UNL, Fuji Film Corporation) were attached to both sides of the polarizer and dried at 60° C. for 5 minutes, thereby preparing a polarizing plate.

Table 1 shows the temperature and the amount of boric acid in the stretching bath, and the amount of potassium iodide in the color correction bath in Examples 1 to 4 and Comparative Examples 1 to 3.

TABLE 1

| | Stretching bath | | | Color correction bath |
|---|---|---|---|---|
| | Temper- | Boric acid | Stretching | Potassium |
| Kind | ature | (wt %) | ratio | iodide (wt %) |
| Example 1 | 55° C. | 3.0 | 2.5 | 4.0 |
| Example 2 | 54° C. | 3.0 | 2.5 | 3.0 |
| Example 3 | 53° C. | 3.2 | 2.5 | 3.0 |
| Example 4 | 60° C. | 3.5 | 2.5 | 4.0 |
| Comparative | 60° C. | 2.0 | 2.5 | 4.0 |
| Example 1 | | | | |
| Comparative | 50° C. | 3.5 | 2.5 | 4.0 |
| Example 2 | | | | |
| Comparative | 54° C. | 3.0 | 2.0 | 3.0 |
| Example 3 | | | | |

Evaluation of Properties

(1) Content of boric acid and potassium iodide (KI): 1 g of the polarizer and 50 g of deionized water were placed in a beaker and heated for complete dissolution. Then, 10 g of a mannitol solution (mannitol: distilled water=1:7 in terms of weight) was added to the resultant, followed by titration with 0.1N aqueous NaOH solution to measure weight percent of boric acid (W_{BA}). In addition, 1 g of the polarizer and 50 g of deionized water were placed in a beaker and heated for complete dissolution, followed by titration with 0.1N aqueous AgNO₃ solution to measure weight percent of potassium iodide (KI) (W_{KI}). Then, the ratio (W_{BA}/W_{KI}) of weight percent of boric acid (W_{BA}) to weight percent of potassium iodide (KI) (W_{KI}) was obtained. Results are shown in Table 2.

TABLE 2

| Kind | Boric acid (wt %) | KI (wt %) | Boric acid/KI (W_{BA}/W_{KI}) |
|---|---|---|---|
| Example 1 | 18.5 | 3.4 | 5.4 |
| Example 2 | 21.5 | 2.6 | 8.3 |
| Example 3 | 22.0 | 3.0 | 7.3 |
| Example 4 | 18.0 | 3.0 | 6.0 |
| Comparative | 17.5 | 4.5 | 3.9 |
| Example 1 | | | |
| Comparative | 22.5 | 2.0 | 11.3 |
| Example 2 | | | |
| Comparative | 24.0 | 1.8 | 13.3 |
| Example 3 | | | |

(2) Orthogonal chromaticity variation (Δab): Each of the samples prepared in the examples and the comparative examples were attached to non-alkali glass and measured as to initial orthogonal chromaticity of the polarizing plate using a V-7100 spectrophotometer (JASCO Corporation, Japan). Then, each of the samples were heated in an oven at 105° C. for 3 hours, followed by measurement of the orthogonal chromaticity of the polarizing plate using the spectrophotometer. An initial orthogonal chromaticity (ac₀, bc₀) of the polarizing plate and an orthogonal chromaticity (ac₃, bc₃) of the polarizing plate after being left at 105° C. for 3 hours were measured on the Hunter color coordinate system to obtain orthogonal chromaticity variation according to Equation 1. Results are shown in Table 3.

Δab=\sqrt{(ac₃−ac₀)²+(bc₃−bc₀)²} (1)

wherein ac₃ and bc₃ are each an orthogonal chromaticity of the polarizer after the polarizer has been left at 105° C. for 3 hours, and ac₀ and bc₀ are each an initial orthogonal chromaticity of the polarizer.

(3) Degree of polarization: A single sheet of a polarizing plate was used to measure parallel transmittance and orthogonal transmittance at 0 and 90 degrees using the spectrophotometer. Then, the degree of polarization was calculated according to the following equation and results are shown in Table 3.

Degree of polarization=\sqrt{(Tp−Tc)/(Tp+Tc)},

wherein Tp is parallel transmittance and Tc is orthogonal transmittance (Y value obtained through luminosity correction in the 2-degree visual field (C illuminant)).

(4) Transmittance: The transmittance of a single sheet of polarizing plate was measured using a spectrophotometer V-7100 (JASCO Corporation, Japan), and results are shown in Table 3. The transmittance of the polarizing plate was the Y value obtained through luminosity correction in the 2-degree visual field (C illuminant) according to JIS Z8701.

(5) Outer appearance and visual evaluation were observed with the naked eye: Each sample was heated in an oven at 85° C. for 500 hours for evaluation. The degree of redness was classified into five levels, that is, 0-level to 4th-level, and a higher degree of redness was indicated by a higher value. Results are shown in Table 3.

TABLE 3

| | | Degree of | | | |
|---|---|---|---|---|---|
| | Orthogonal | polarization (%) | | | Visual |
| | chromaticity | | After being | Outer | evaluation |
| | variation | | left at 105° C. | appear- | with |
| Kind | (Δab) | Initial | for 3 hours | ance | naked eye |
| Example 1 | 1.7 | 99.99 | 99.96 | Good | 0 |
| Example 2 | 1.4 | 99.98 | 99.96 | Good | 0 |
| Example 3 | 1.6 | 99.97 | 99.97 | Good | 1 |
| Example 4 | 1.8 | 99.98 | 99.97 | Good | 0 |
| Comparative | 4.8 | 99.97 | 99.93 | Good | 4 |
| Example 1 | | | | | |
| Comparative | 4.5 | 99.98 | 99.92 | Good | 4 |
| Example 2 | | | | | |
| Comparative | 5.0 | 99.95 | 99.90 | Good | 4 |
| Example 3 | | | | | |

In Table 2 and Table 3, it can be seen that the polarizing plates prepared in Examples 1 to 4, which have a ratio (W_{BA}/W_{KI}) of weight percent of boric acid (W_{BA}) to weight percent of potassium iodide (W_{KI}) in the range of 5 to 10, exhibited good optical durability and low chromaticity variation under high temperature conditions. On the contrary, the polarizing plates prepared in Comparative Examples 1 to 3, which have a ratio (W_{BA}/W_{KI}) of less than 5 or greater than 10, exhibited high chromaticity variation.

By way of summation and review, a polarizing plate may be arranged on an outside the LCD panel as part of an LCD display device. The polarizing plate may control polarization of light by selectively transmitting a light component in a specific direction therethrough among light emitted from a backlight unit and light having passed through a liquid crystal layer of the LCD panel.

The polarizing plate may include a polarizer capable of polarizing light in a specific orientation and a protective layer for supporting and protecting the polarizer. The polarizer may be fabricated by dyeing a polyvinyl alcohol film with dichroic iodine, followed by crosslinking the polyvinyl alcohol film with boric acid or the like.

A polarizer having high optical durability is sought. However, a method of preventing red color leakage at high temperature includes impregnating zinc ions into a polarizer. This method disadvantageously reduces the degree of polarization by increasing orthogonal transmittance of light in a short wavelength band, or can cause bluish discoloration of the polarizing plate.

In another method, the amounts of iodine (I) and potassium (K) in a polarizer are adjusted to control optical durability and color variation upon heating. However, this method simply relates to an adjustment of the KI amounts in the fabrication of the polarizer. Thus, if the KI amounts are excessively decreased in the polarizer in order to improve durability of the polarizer, it becomes difficult to adjust chromaticity. Further, if the KI amounts are excessively increased in the polarizer, the remaining amount of iodine (I) and potassium (K) on the surface of the polarizer provide an adverse effect in terms of durability.

In contrast, embodiments relate to a polarizer having high durability and a method of fabricating the same. For example, embodiments relate to a polarizer that is fabricated by adjusting the amounts of boric acid and potassium iodide within certain ranges to ensure excellent optical durability and small chromaticity variation, and a method of fabricating the same.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A polarizer, comprising:
boric acid and potassium iodide, a ratio of weight percent of the boric acid to weight percent of the potassium iodide being from about 5 to about 10 in the polarizer.

2. The polarizer as claimed in claim 1, wherein the ratio is from about 6.5 to about 8.5.

3. The polarizer as claimed in claim 1, wherein the ratio is from about 5 to about 6.

4. The polarizer as claimed in claim 1, wherein the polarizer includes about 18 wt % to about 22 wt % of boric acid and about 2 wt % to about 4 wt % of potassium iodide.

5. The polarizer as claimed in claim 1, wherein:
the polarizer has an orthogonal chromaticity variation (Δab) from about 1 to about 4 as calculated by Equation 1:
Δab=\sqrt{(ac₃−ac₀)²+(bc₃−bc₀)²} (1)
ac₃ and bc₃ each represent an orthogonal chromaticity of the polarizer after the polarizer has been left at 105° C. for 3 hours, and ac₀ and bc₀ each represent an initial orthogonal chromaticity of the polarizer.

6. The polarizer as claimed in claim 5, wherein the orthogonal chromaticity variation (Δab) is from about 1.5 to about 2.

7. The polarizer as claimed in claim 1, wherein the boric acid and the potassium iodide are dispersed in an elongated polyvinyl alcohol film.

8. The polarizer as claimed in claim 7, wherein the boric acid is contained in an amount from about 18 wt % to about 22 wt % in the elongated polyvinyl alcohol film and the boric acid is contained in an amount from about 2 wt % to about 4 wt % in the elongated polyvinyl alcohol film.

9. A polarizing plate, comprising a protective film stacked on at least one side of the polarizer claimed in claim 1.

10. A method of fabricating a polarizer, the method comprising:
stretching a polyvinyl alcohol film while dyeing the polyvinyl alcohol film in a dyeing bath containing iodine and potassium iodide to form a dyed polyvinyl alcohol film;
stretching the dyed polyvinyl alcohol film in a stretching bath containing boric acid and potassium iodide to form a stretched polyvinyl alcohol film; and
stretching the stretched polyvinyl alcohol film in a color correction bath containing boric acid and potassium iodide.

11. The method as claimed in claim 10, wherein:
the stretching bath contains about 2.5 wt % to about 3.5 wt % of boric acid, about 2.5 wt % to about 3.5 wt % of potassium iodide, and a balance of water, and
during stretching of the dyed polyvinyl alcohol film, the stretching bath is maintained at a temperature of about 45° C. to about 65° C.

12. The method as claimed in claim 10, wherein:
the color correction bath contains about 0.8 wt % to about 1.2 wt % of boric acid, about 3.0 wt % to about 4.0 wt % of potassium iodide, and a balance of water, and
during stretching of the stretched polyvinyl alcohol film, the color correction bath is maintained at a temperature of about 35° C. to about 45° C.

13. The method as claimed in claim 10, wherein the polyvinyl alcohol film is stretched to a first cumulative stretching ratio of about 1.5 to about 2.2 in the dyeing bath, the dyed polyvinyl alcohol film is stretched to a second cumulative stretching ratio of about 2.0 to about 3.2 in the stretching bath, and the stretched polyvinyl alcohol film is stretched to a total stretching ratio of about 5 to about 6.5 in the color correction bath.

14. The method as claimed in claim 13, further comprising, prior to stretching the polyvinyl alcohol film in the dyeing bath, swelling a precursor polyvinyl alcohol film in a swelling bath to a preliminary stretching ratio of about 1.1 to about 1.6.

15. The method as claimed in claim 10, wherein stretching the stretched polyvinyl alcohol film in the color correction bath forms an elongated polyvinyl alcohol film that includes boric acid and potassium iodide, a ratio of weight percent of the boric acid to weight percent of the potassium iodide being from about 5 to about 10.

16. The method as claimed in claim 15, wherein the ratio in the elongated polyvinyl alcohol film is from about 6.5 to about 8.5.

17. The method as claimed in claim 15, wherein the ratio in the elongated polyvinyl alcohol film is from about 5 to about 6.
